(19) United States
(12) Patent Application Publication
(10) Pub. No.: US 2026/0112829 A1
(43) Pub. Date: Apr. 23, 2026

(54) Vertical Module Connector with Pin-Clamp Mechanism

(71) Applicant: Advanced Micro Devices, Inc., Santa Clara, CA (US)

(72) Inventors: Aaron John Nygren, Boise, ID (US); Christopher Edward Cox, Placerville, CA (US)

(73) Assignee: Advanced Micro Devices, Inc., Santa Clara, CA (US)

(21) Appl. No.: 19/253,624

(22) Filed: Jun. 27, 2025

Related U.S. Application Data
(60) Provisional application No. 63/709,921, filed on Oct. 21, 2024.

(51) Int. Cl. H01R 12/73; G06F 1/18; H01R 12/88; H01R 12/89; H01R 43/26

(52) U.S. Cl. CPC H01R 12/737; G06F 1/185; H01R 12/88; H01R 12/89; H01R 43/26

(57) ABSTRACT

Systems and techniques for vertical module connectors with pin-clamp mechanisms are described. An example module connector includes two cross-members, with each cross-member including at least one row of pins. Upon insertion, the pins are arranged to make electrical contact with pins on a memory module (e.g., a dual in-line memory module (DIMM)). The module connector also includes a clamping mechanism (e.g., a hinge assembly) that closes a first cross-member against or towards a second cross-member in response to or after insertion of the memory module. The module connector further includes a locking mechanism to maintain a closed state of the two cross-members and provide electrical contact between the row of pins on each cross-member and pins on the memory module. The described module connector allows for the insertion of memory modules with increased pins without reduced insertion force.

### BACKGROUND

Memory modules, such as dual in-line memory modules (DIMMs), are widely used in computing systems to provide high-capacity and high-performance memory. These modules typically connect to a motherboard or other circuit board through connectors that allow for electrical communication between the memory chips on the module and other system components. New memory technologies such as Double Data Rate 6 (DDR6) will likely introduce additional pins (e.g., adding one or more pin rows) on the end of each DIMM to increase pin density and signal integrity for the increasing memory capacity and bandwidth. The increased number of pins increases the insertion force to install the DIMMs into conventional connectors on a motherboard. The increased force will likely exceed prescribed force limits and damage the printed circuit boards (PCBs).

### BRIEF DESCRIPTION OF THE DRAWINGS

FIG. 1 depicts a block diagram of a processing system configured to execute one or more applications in accordance with one or more implementations.

FIG. 2 depicts a non-limiting example of a DIMM connectable to a vertical module connector with a pin-clamp mechanism.

FIGS. 3A, 3B, 3C, and 3D depict a non-limiting example vertical module connector with a pin-clamp mechanism.

FIG. 4 illustrates a procedure for using a module connector with a pin-clamp mechanism.

### DETAILED DESCRIPTION

### Overview

Many computing devices, including desktop computers, laptops, servers, and workstations, utilize DIMMs to expand their memory capacity. Each DIMM generally includes multiple memory chips mounted on a printed circuit board (PCB), which provides connections between the memory chips and other components. The PCB also includes pins to connect the DIMM to memory slots in a motherboard, which can include different numbers of DIMM slots, ranging from one to four or more.

As the density and data transfer rates of memory chips improve and the number of memory chips included on a DIMM increases, DIMMs will likely introduce additional pins (e.g., one or more additional pin rows) to improve signal integrity between the DIMM and motherboard. The increased number of pins increases the insertion force to insert DIMMs into conventional connectors on the motherboard.

Conventional DIMM connectors include a series of metal prongs (or fingers) that the DIMM slides past as the DIMM is inserted into the connector. Upon insertion, the metal prongs are in contact with the DIMM pins. However, as the number of pins increases, the total insertion force to slide past the increased number of metal prongs proportionally increases, surpassing prescribed force limits if the number of new pins is sufficiently large.

In contrast, the described techniques and systems for a vertical module connector with a pin-clamp mechanism provide an insertion process that is not proportional to the number of DIMM pins and reduces the insertion force below the standardized insertion force limits. Instead of sliding past connection prongs during insertion, the described techniques use a clamp mechanism that brings the prongs and a portion of the connector down into contact with the DIMM pins upon insertion. In this way, the insertion force is engineered to remain below the prescribed limits, regardless of the number of pins added to DIMMs. In addition, the described pin-clamp mechanism avoids potential pin scraping from the conventional connector mechanism as the pins are slid into place against the metal prongs.

In one implementation, the vertical module connector includes two cross-members, each including at least one row of pins. A clamping mechanism closes a first cross-member against a second cross-member in response to inserting a printed circuit board into the connector. A locking mechanism maintains the closed state of the two cross-members, ensuring electrical contact between the connector pins and the pins on the printed circuit board. This design allows easy memory module insertion with minimal force, followed by secure clamping to establish the electrical connections.

By decoupling the insertion process from the number of pins, the described vertical module connector with a pin-clamp mechanism enables the use of memory modules with increased pin counts without compromising the ease of installation or damaging system components. This approach provides a scalable solution for accommodating future memory technologies that may use even greater pin densities to support higher capacities and bandwidths. The reduced insertion force and elimination of pin scraping also contribute to improved reliability and longevity of the memory modules and the connectors.

In some aspects, the described techniques and systems related to a module connector that includes two cross-members, each cross-member including at least one row of pins, a clamping mechanism configured to close a first cross-member of the two cross-members against a second cross-member in response to an insertion of a printed circuit board (PCB) into the module connector, and a locking mechanism configured to maintain a closed state of the two cross-members and provide electrical contact between the at least one row of pins on each cross-member and pins on the PCB.

In some aspects, the described techniques and systems related to a module connector wherein the first cross-member is a fixed cross-member and the second cross-member is a movable cross-member.

In some aspects, the described techniques and systems related to a module connector further comprising a hinge connecting the fixed cross-member and the movable cross-member.

In some aspects, the described techniques and systems related to a module connector wherein each cross-member and the PCB include two or more rows of pins.

In some aspects, the described techniques and systems related to a module connector further comprising at least one side latch configured to secure the PCB in the module connector.

In some aspects, the described techniques and systems related to a module connector wherein the module connector is configured to accommodate a dual in-line memory module (DIMM).

In some aspects, the described techniques and systems related to a module connector wherein the clamping mechanism includes a lever arm configured to apply pressure to the second cross-member, a cam mechanism configured to translate rotational motion into linear motion to close the first cross-member against the second cross-member, a spring-loaded actuator configured to bias the first cross-member towards the closed state, a sliding mechanism configured to move the first cross-member laterally towards the second cross-member, or a threaded fastener configured to draw the first cross-member and the second cross-member together when rotated.

In some aspects, the described techniques and systems related to a module connector wherein the locking mechanism includes a snap-fit mechanism configured to engage when the two cross-members are in the closed state, a sliding latch configured to secure the two cross-members in the closed state, a rotatable cam lock configured to apply pressure to maintain the closed state, a magnetic locking system configured to hold the two cross-members together, or a spring-loaded pin configured to engage a corresponding recess when the two cross-members are closed.

In some aspects, the described techniques and systems related to a module connector wherein the at least one row of pins on each cross-member includes conductive metal contacts arranged in a linear array, spring-loaded pins configured to maintain consistent electrical contact with the PCB, plated through-holes designed to receive corresponding pins from the PCB, surface-mount pads arranged to align with contact points on the PCB, or compliant pin technology providing a pressure fit connection when engaged with the PCB.

In some aspects, the described techniques and systems related to a module connector wherein the pins on the PCB include gold-plated contact pads arranged in one or more linear arrays along an edge of the PCB, through-hole pins extending from a surface of the PCB, surface-mount technology (SMT) pads configured to align with corresponding contacts on the two cross-members, ball grid array (BGA) contacts distributed across a connection area of the PCB, or edge connector fingers formed as conductive traces on the surface of the PCB.

In some aspects, the described techniques and systems related to an apparatus comprising a motherboard configured to receive a memory module, a module connector disposed on the motherboard, the module connector comprising two cross-members, each cross-member including at least one row of pins, a clamping mechanism configured to close a first cross-member of the two cross-members against a second cross-member in response to an insertion of the memory module into the module connector, and a locking mechanism configured to maintain a closed state of the two cross-members and provide electrical contact between the at least one row of pins on each cross-member and pins on the memory module.

In some aspects, the described techniques and systems related to an apparatus wherein the first cross-member is a fixed cross-member and the second cross-member is a movable cross-member.

In some aspects, the described techniques and systems related to an apparatus wherein the module connector further comprises a hinge connecting the fixed cross-member and the movable cross-member.

In some aspects, the described techniques and systems related to an apparatus wherein each cross-member and the memory module include two or more rows of pins.

In some aspects, the described techniques and systems related to an apparatus wherein the module connector further comprises at least one side latch configured to secure the memory module in the module connector.

In some aspects, the described techniques and systems related to an apparatus wherein the memory module is a dual in-line memory module (DIMM).

In some aspects, the described techniques and systems related to an apparatus wherein the clamping mechanism includes at least one of a lever arm configured to apply pressure to the second cross-member, a cam mechanism configured to translate rotational motion into linear motion to close the first cross-member against the second cross-member, a spring-loaded actuator configured to bias the first cross-member towards the closed state, a sliding mechanism configured to move the first cross-member laterally towards the second cross-member, or a threaded fastener configured to draw the first cross-member and the second cross-member together when rotated.

In some aspects, the described techniques and systems related to an apparatus wherein the locking mechanism includes at least one of a snap-fit mechanism configured to engage when the two cross-members are in the closed state, a sliding latch configured to secure the two cross-members in the closed state, a rotatable cam lock configured to apply pressure to maintain the closed state, a magnetic locking system configured to hold the two cross-members together, or a spring-loaded pin configured to engage a corresponding recess when the two cross-members are closed.

In some aspects, the described techniques and systems related to an apparatus wherein the motherboard includes input/output circuitry configured to manage communications between the memory module and other components of the apparatus.

In some aspects, the described techniques and systems related to a method comprising aligning a printed circuit board (PCB) with two cross-members of a module connector, each cross-member including at least one row of pins, inserting the PCB into the module connector, activating a clamping mechanism to close a first cross-member of the two cross-members against a second cross-member in response to insertion of the PCB, and engaging a locking mechanism to maintain a closed state of the two cross-members to establish electrical contact between the at least one row of pins on each cross-member and pins on the PCB.

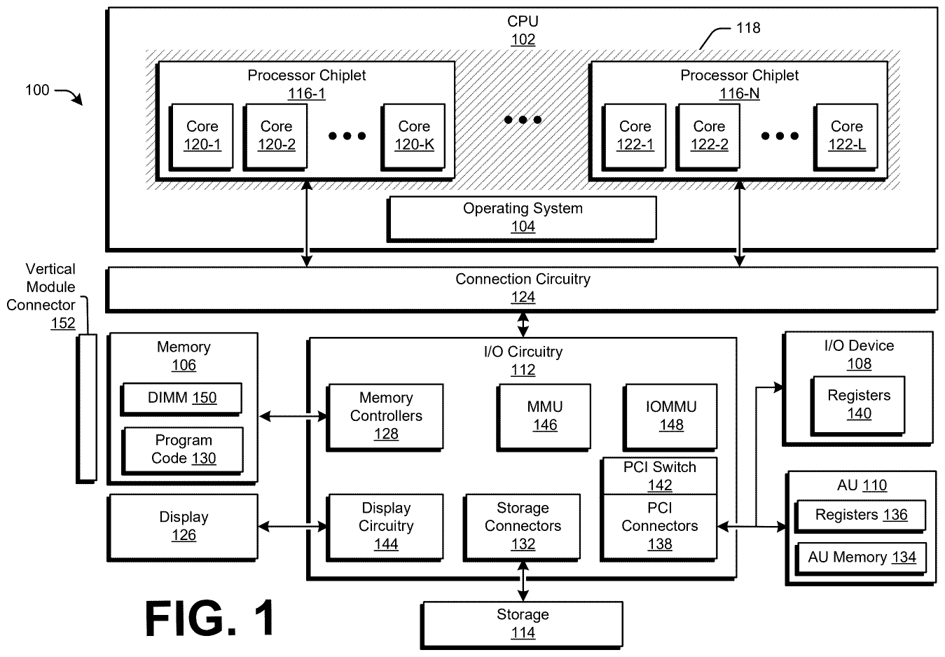

FIG. 1 is a block diagram of a processing system configured to execute one or more applications in accordance with one or more implementations. In particular, FIG. 1 includes a processing system 100 configured to execute one or more applications, such as computing applications (e.g., machine-learning applications, neural network applications, high-performance computing applications, databasing applications, gaming applications), graphics applications, and the like. Examples of devices in which the processing system 100 is implemented include but are not limited to a server computer, personal computer (e.g., desktop or tower computer), notebook computer, laptop computer, entertainment device (e.g., gaming console, television, set-top box), automotive computer or computer for another type of vehicle, networking device, medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

The CPU 102 includes one or more processor chiplets 116, which are communicatively coupled by a data fabric 118 in one or more implementations. Each processor chiplet 116, for example, includes one or more processor cores 120, 122 configured to execute one or more series of instructions concurrently, also referred to herein as “threads” or workloads, for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116.

Though the example implementation in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections that are usable to implement the data fabric 118 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. The memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, the memory controllers 128 are configured to manage access to the data stored at one or more memory addresses within the system memory 106, such as by CPU 102, I/O device 108, and/or AU 110. In this example, the memory 106 includes one or more DIMMs 150 that are inserted into vertical module connector(s) 152 to operatively connect to the motherboard and the connection circuitry 124.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

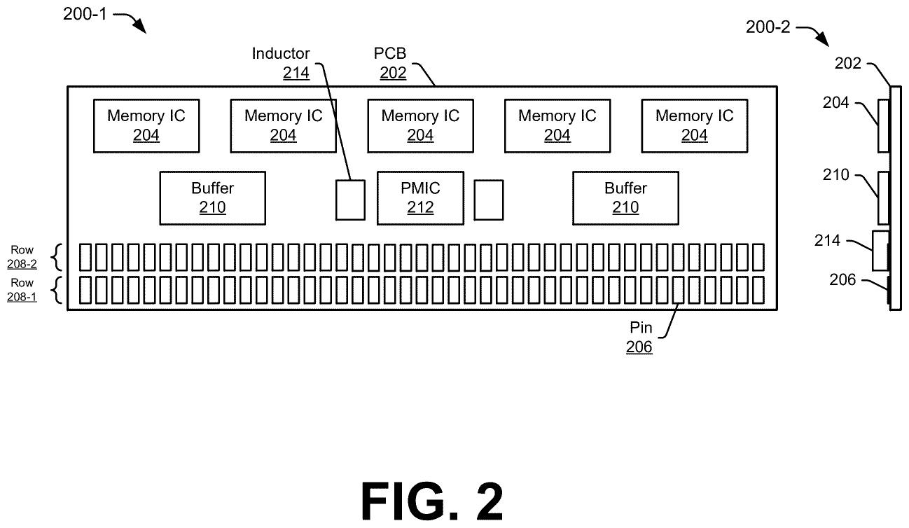

FIG. 2 depicts a non-limiting example of a DIMM connectable to a vertical module connector with a pin-clamp mechanism from a top view 200-1 and a side view 200-2.

A memory module, such as a DIMM, is a circuit board (e.g., a printed circuit board (PCB) 202) on which volatile memory and/or non-volatile memory are mounted. In other implementations, the memory module is a Transflash memory module, a single in-line memory module (SIMM), or another type of memory module incorporated into the PCB 202. The volatile and non-volatile memory correspond to semiconductor memory, where data is stored within memory cells on one or more memory integrated circuits (ICs) 204.

Broadly, the volatile memory retains data as long as a device is connected to power, and the data is accessible relatively faster than the non-volatile memory. Examples of volatile memory include random-access memory (RAM), dynamic random-access memory (DRAM), synchronous dynamic random-access memory (SDRAM), and static random-access memory (SRAM). For example, the memory ICs 204 are volatile memory utilizing double data rate (DDR) memory technology (e.g., DDR, DDR2, DDR3, DDR4, DDR5, and/or DDR6 technology).

Non-volatile memory retains data even after the device is disconnected from power, but it is accessible relatively slower than volatile memory. Examples of non-volatile memory include solid state disks (SSD), flash memory, read-only memory (ROM), programmable read-only memory (PROM), erasable programmable read-only memory (EPROM), and electronically erasable programmable read-only memory (EEPROM).

As described above, memory modules, such as DIMMs, include the PCB 202 with various components, including, as a non-limiting example, one or more memory ICs 204, multiple pins 206, one or more buffers 210, a power manager IC (PMIC) 212, and one or more inductors 214. The PCB 202 is a physical board that houses the memory ICs 204 and provides electrical connections. The memory ICs 204 are the storage elements on the PCB 202 where data is stored. In some implementations, the memory ICs are arranged in a two-dimensional or three-dimensional grid on the PCB 202. The pins 206 are generally gold-plated contacts that connect the DIMM or other memory module to the motherboard's memory slots to ensure a reliable electrical connection. The buffers 210 temporarily store data being read from or written to the memory ICs 204. The PMIC 212 regulates the power supply to the DIMM or other memory module to ensure operation at the correct voltage and current levels. The inductors 214 filter or suppress electrical noise or store energy to regulate the power on one or more power rails on the PCB 202. Although not illustrated, the PCB 202 often includes an address decoder to decode the address signals received from the motherboard to select the appropriate memory IC 204, a clock generator to generate the clock signals that control the timing of operations with the DIMM, capacitors, and resistors, power rails, and other componentry.

As described above, DIMMs currently include a single row of pins to provide electrical connections between the PCB 202 and other system components. However, as the memory technology advances (e.g., to DDR6) and additional components are added to the memory modules, additional pin rows may be added to the PCB 202 to enhance connectivity and support increased data transfer rates. For example, FIG. 2 illustrates a first row 208-1 and a second row 208-2 of pins 206. In other implementations, the PCB 202 may include additional pin rows, including three or four rows. In other implementations, additional pins may be added to the PCB 202 without adding additional rows 208 (e.g., by reducing the size of each pin 206).

Memory modules are configurable to support various pin types on the PCB 202, including gold-plated contact pads arranged in linear arrays along the edge of the PCB 202, through-hole pins extending from the PCB surface, surface-mount technology (SMT) pads configured to align with corresponding contacts on the module connector, ball grid array (BGA) contacts distributed across a connection area of the PCB 202, or edge connector fingers formed as conductive traces on the PCB surface. The pin rows 208-1 and 208-2 are designed with sufficient density and signal integrity to support the increased data throughput set forth by evolving standards. The layout of the pin rows 208 can be optimized to minimize signal crosstalk and maintain consistent electrical characteristics across the connections.

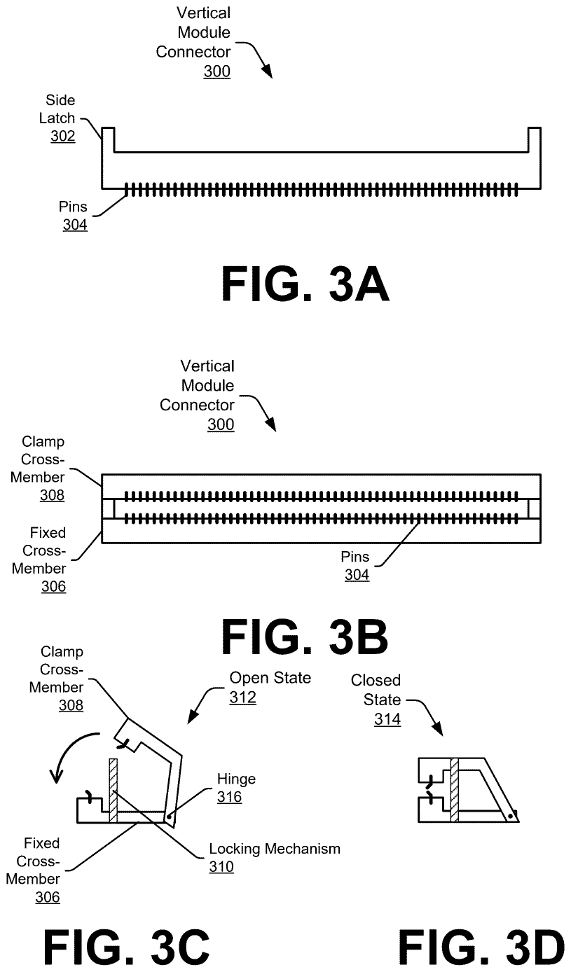

FIGS. 3A, 3B, 3C, and 3D depict a non-limiting example vertical module connector 300 with a pin-clamp mechanism. In particular, FIGS. 3A and 3B provide a top and front view of the vertical module connector 300, respectively. FIGS. 3C and 3D provide a side view of the vertical module connector 300 in an open and closed state. Although described as a vertical module connector, in other implementations, the vertical module connector 300 can be replaced with a horizontal or angled module connector configured to receive a DIMM or similar module. The vertical module connector 300 is configured to receive and secure a printed circuit board (PCB) such as a memory module.

In one or more implementations, the vertical module connector 300 is disposed on a motherboard configured to receive a memory module. The motherboard includes input/output circuitry configured to manage communications between the memory module and other apparatus components.

The vertical module connector 300 includes side latches 302 and a series of pins 304. The side latches 302 provide a mechanism to lock the PCB 202 within the vertical module connector 300 after insertion. For example, the PCB 202 includes small notches on the lateral sides, and the side latches 302 are physically or automatically closed upon insertion of the PCB 202 to prevent the backward movement or retraction of the PCB 202.

The pins 304 on the vertical module connector 300 are configured to align with the pins 206 on the PCB 202. If the PCB 202 includes multiple pin rows 208, then the vertical module connector 300 is configured to include the same number of pin rows to provide an electrical connection between each pin 206 on the PCB 202 and the motherboard to which the vertical module connector 300 is connected. The pins 304 on the cross-members include conductive metal contacts arranged in a linear array. Additionally, or alternatively, the pins 304 include spring-loaded pins configured to maintain consistent electrical contact with the PCB, plated through-holes designed to receive corresponding pins from the PCB, surface-mount pads arranged to align with contact points on the PCB, or compliant pin technology providing a pressure fit connection when engaged with the PCB.

The input/output circuitry for managing communications between the memory module and other components may include a combination of hardware and firmware elements. This circuitry may comprise data buffers, multiplexers, and signal conditioning components to facilitate bi-directional data transfer. The I/O circuitry may implement memory-specific protocols such as DDR4, DDR5, or DDR6, allowing for high-speed data transmission between the memory module and other system components. In some aspects, the circuitry may incorporate error detection and correction mechanisms, such as cyclic redundancy checks (CRC) or error-correcting code (ECC), to maintain data integrity during transfers. The I/O circuitry may include clock synchronization elements to align data transmission with system timing. Additionally, the circuitry may feature power management capabilities, potentially utilizing dynamic voltage and frequency scaling (DVFS) techniques to optimize energy consumption across different operational modes. In some implementations, the I/O circuitry may include serializer/deserializer (SerDes) components to convert parallel data streams to serial for efficient transmission over high-speed interfaces. The circuitry may also incorporate impedance-matching networks to minimize signal reflections and maintain signal integrity across the communication channels between the memory module and other system components.

For the pin-clamp mechanism, the vertical module connector 300 includes a fixed cross-member 306 and clamp cross-member 308 as illustrated in the front view of FIG. 3B. The fixed cross-member 306 and the clamp cross-member 308 include a series of pins 304. The side latches 302 can be integrated on either the fixed cross-member 306 and/or the clamp cross-member 308. Before insertion and clamping, the separation distance between the pins 304 of the clamp cross-member 308 and the fixed cross-member 306 is wider than the thickness of the combination of the PCB 202 and pins 206 (as illustrated in FIG. 3C with the clamp cross-member 308 in an open state 312).

The vertical module connector 300 operates in two primary states: the open state 312 and a closed state 314. In the open state 312, as shown in FIG. 3C, the clamp cross-member 308 is positioned away from the fixed cross-member 306, creating a space for inserting a printed circuit board (PCB). The open state 312 allows for easy alignment and insertion of the PCB into the vertical module connector 300.

A DIMM is inserted in contact with or just above the pins 304 of the fixed cross-member 306. Upon completed insertion of the PCB 202 into the vertical module connector 300, the clamp cross-member 308 is closed (e.g., moved in a perpendicular direction) so that the pins 304 contact the pins 206 of the PCB 202 (as illustrated in FIG. 3D with the clamp cross-member 308 in a closed state 314). In this way, the vertical module connector 300 allows pin-clamping action by moving the clamp cross-member 308 relative to the fixed cross-member 306 via a hinge 316. This clamping action ensures a secure electrical connection between the pins 304 on the cross-members and the corresponding contacts on the inserted PCB.

In one implementation, the clamp cross-member 308 is physically moved to the closed state 314 by a technician before or after the side latches 302 are closed. In one implementation, the clamp cross-member 308 is attached via the hinge 316 to the fixed cross-member 306 and spring-loaded to default to the open state 312. A vertical latch or locking mechanism 310 is used to maintain the clamp cross-member 308 in the closed state 314 and apply sufficient downward force to maintain a good electrical connection between pins 304 and pins 206. In another implementation, both the clamp cross-member 308 and fixed cross-member 306 are movable but operate similarly to provide the pin-clamp mechanism. Removal of the PCB 202 from the vertical module connector 300 is accomplished by releasing the side latches 302 and locking mechanism 310 (or vice versa) and physically retracting the PCB 202.

In another implementation, the vertical module connector 300 includes a spring release or similar mechanism that allows the clamp cross-member 308 to move to the closed state 314 upon sufficient insertion of the PCB 202. For example, the clamp cross-member 308 can be attached via another or similar hinge 316 to the fixed cross-member 306 and spring-loaded to default to the closed state 314. Before insertion, the clamp cross-member 308 is moved to an open state 312 and temporarily fixed using a catch or similar mechanism. Upon or during insertion of the PCB 202, a spring release or similar mechanism releases the catch and allows the clamp cross-member 308 to return to the closed state 314 with the pins 304 in contact with the pins 206.

In one implementation, the clamping mechanism includes a lever arm configured to apply pressure to the clamp cross-member 308. As the lever arm is actuated, the lever arm exerts force on the clamp cross-member 308, causing it to rotate around the hinge 316 and move towards the fixed cross-member 306. Additionally, or alternatively, the clamping mechanism includes a cam mechanism configured to translate rotational motion into linear motion to close the clamp cross-member 308 against the fixed cross-member 306. The cam mechanism allows for a smooth and controlled closing action, ensuring even pressure distribution along the length of the cross-members. In some implementations, the clamping mechanism includes a sliding mechanism configured to move the clamp cross-member 308 laterally towards the fixed cross-member 306. This sliding mechanism provides a linear closing motion, which can be beneficial for maintaining the alignment of the pins during the closing process. In another implementation, the vertical module connector 300 also incorporates a spring-loaded actuator configured to bias the clamp cross-member 308 towards the closed state 314. This spring-loaded actuator assists in maintaining consistent pressure on the PCB once it is inserted and the connector is closed.

For applications requiring a more secure connection, the clamping mechanism includes a threaded fastener configured to draw the fixed cross-member 306 and the clamp cross-member 308 together when rotated. This threaded fastener allows for fine adjustment of the clamping force and provides a robust mechanical connection.

In another implementation, the locking mechanism includes a snap-fit mechanism configured to engage when the fixed cross-member 306 and the clamp cross-member 308 are in the closed state 314. This snap-fit mechanism provides audible and tactile feedback to the user, confirming that the connector is securely closed. Additionally, or alternatively, the locking mechanism includes a sliding latch configured to secure the fixed cross-member 306 and the clamp cross-member 308 in the closed state 314. The sliding latch offers a simple and effective method for locking the connector, allowing for quick engagement and disengagement. In some implementations, the locking mechanism incorporates a magnetic locking system configured to hold the fixed cross-member 306 and the clamp cross-member 308 together. The magnetic locking system offers a contactless lock, reducing wear and tear on mechanical components while providing a secure connection.

The vertical module connector 300 is designed to provide a secure and reliable connection for PCBs, particularly memory modules while offering flexibility regarding module size and electrical configuration. Combining the fixed cross-member 306, clamp cross-member 308, locking mechanism 310, and side latch 302 ensures that inserted modules are firmly in place and maintain proper electrical contact through the pins 304.

The various functional units illustrated in the figures and/or described herein (including, where appropriate, the PCB 202 and vertical module connector 300) are implemented in any of a variety of different manners such as hardware circuitry, software or firmware executing on a programmable processor, or any combination of two or more of hardware, software, and firmware. The methods provided are implemented in various devices, such as general-purpose computers, processors, or processor cores.

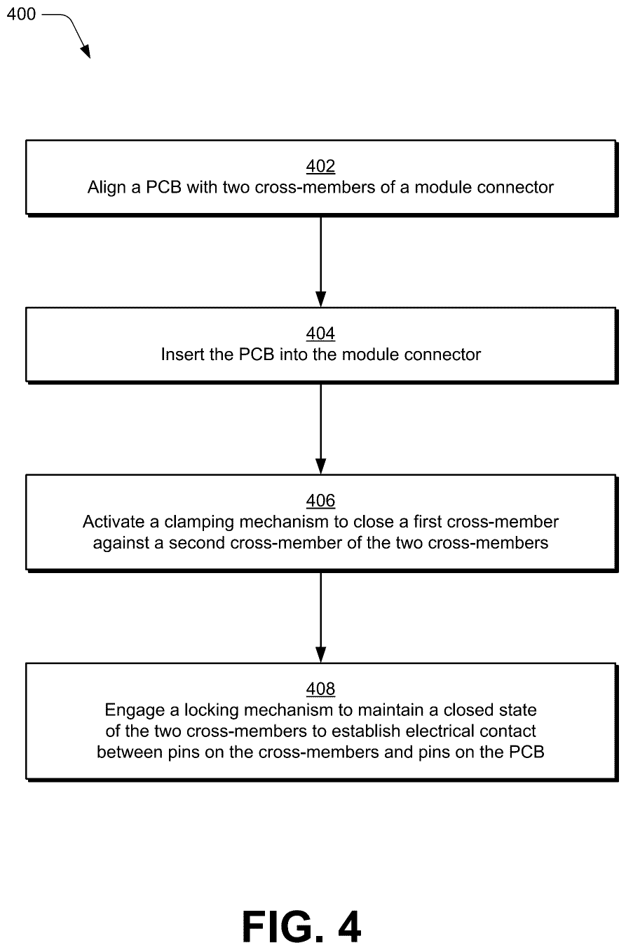

FIG. 4 illustrates a procedure 400 for using a module connector with a pin-clamp mechanism. The order in which the method is described is not intended to be construed as a limitation, and any number or combination of the described operations can be performed in any order to perform the procedure 400 or an alternate procedure.

To begin, a printed circuit board (PCB) is aligned with two cross-members of a module connector, each cross-member including at least one row of pins (block 402). The PCB is inserted into the module connector with two cross-members (block 404). For example, the PCB may be a memory module such as a dual in-line memory module (DIMM) that is inserted vertically into the module connector.

A clamping mechanism is activated to close the first cross-member of the two cross-members against a second cross-member in response to the insertion of the PCB (block 406). For example, the first cross-member is a fixed cross-member and the second cross-member is a movable cross-member connected by a hinge. In some implementations, the clamping mechanism includes a lever arm configured to apply pressure to the second cross-member, a cam mechanism configured to translate rotational motion into linear motion to close the first cross-member against the second cross-member, a spring-loaded actuator configured to bias the first cross-member towards the closed state, a sliding mechanism configured to move the first cross-member laterally towards the second cross-member, or a threaded fastener configured to draw the first cross-member and the second cross-member together when rotated.

The vertical module connector may include a spring-loaded actuator comprising a compression spring and a plunger assembly. In some implementations, the actuator is mounted adjacent to the clamp cross-member 308, with the plunger positioned to exert force on a portion of the cross-member. The compression spring may be housed within a cylindrical casing, with one end fixed and the other connected to the plunger. When the clamp cross-member 308 is open, the spring is compressed, storing potential energy. Upon release of the locking mechanism 310, the stored energy in the spring drives the plunger to push against the clamp cross-member 308, biasing it towards the closed state 314. This spring-loaded mechanism helps maintain consistent pressure between the pins 304 on the cross-members and the corresponding contacts on the inserted PCB 202.

In some implementations, the vertical module connector 300 may include a detection mechanism to sense the insertion of the PCB 202. This detection mechanism may comprise one or more optical sensors, mechanical switches, or capacitive sensors positioned near the entry point of the connector. Upon detecting the presence of the PCB 202, the sensor may trigger an electronic control unit that activates the clamping mechanism. The electronic control unit may send a signal to an actuator, such as a solenoid or a small electric motor, which then initiates the movement of the clamp cross-member 308 toward the closed state 314. In some cases, the actuator may be directly coupled to the hinge 316 or operate through a series of gears or levers to translate the actuation force into the desired clamping motion. The detection and clamping process may be designed to occur rapidly, ensuring that the PCB 202 is secured as soon as it is fully inserted into the vertical module connector 300.

A locking mechanism maintains a closed state of the two cross-members to establish electrical contact between at least one row of pins on each cross-member and pins on the PCB (block 408). For example, the locking mechanism includes a snap-fit mechanism configured to engage when the two cross-members are in the closed state, a sliding latch configured to secure the two cross-members in the closed state, a rotatable cam lock configured to apply pressure to maintain the closed state, a magnetic locking system configured to hold the two cross-members together, or a spring-loaded pin configured to engage a corresponding recess when the two cross-members are closed.

In some implementations, the locking mechanism may include a cam-actuated pressure plate that applies uniform force across the length of the cross-members when engaged. This pressure plate may be coupled to a lever or knob that, when rotated, drives the cam to press the plate against the back of the clamp cross-member. The pressure plate may incorporate conductive elements or spring contacts that align with the pins on the cross-members, ensuring consistent electrical contact is maintained even if there are slight variations in PCB thickness or pin height. A ratcheting system integrated into the cam mechanism may allow for fine adjustments to the applied pressure, enabling the user to optimize the connection for different PCB specifications. The locking mechanism may also feature a secondary latching system, such as spring-loaded detents or a sliding bar, that prevents accidental disengagement of the pressure plate during operation.

The magnetic locking system may include a series of electromagnets embedded within the fixed cross-member and corresponding ferromagnetic elements integrated into the clamp cross-member. When activated, these electromagnets generate a magnetic field that attracts the ferromagnetic elements, pulling the cross-members together and maintaining the closed state. The strength of the magnetic field may be adjustable through variable current control, allowing for fine-tuning of the clamping force to accommodate different PCB thicknesses or pin configurations. In some implementations, the magnetic locking system may incorporate a failsafe mechanism, such as a mechanical interlock that engages when power is lost, ensuring the connector remains securely closed even during an electrical failure. Using electromagnets in the locking system may provide the additional benefit of allowing for rapid and controlled release of the PCB when needed, simply by reversing the current flow or deactivating the magnetic field.

It should be understood that many variations are possible based on the disclosure herein. Although features and elements are described above in particular combinations, each feature or element is usable alone without the other features and elements or in various combinations with or without other features and elements.

What is claimed is:

1. A module connector comprising:
two cross-members, each cross-member including at least one row of pins;
a clamping mechanism configured to close a first cross-member of the two cross-members against a second cross-member in response to an insertion of a printed circuit board (PCB) into the module connector; and
a locking mechanism configured to maintain a closed state of the two cross-members and provide electrical contact between the at least one row of pins on each cross-member and pins on the PCB.

2. The module connector of claim 1, wherein the first cross-member is a fixed cross-member and the second cross-member is a movable cross-member.

3. The module connector of claim 2, further comprising a hinge connecting the fixed cross-member and the movable cross-member.

4. The module connector of claim 1, wherein each cross-member and the PCB include two or more rows of pins.

5. The module connector of claim 1, further comprising at least one side latch configured to secure the PCB in the module connector.

6. The module connector of claim 1, wherein the module connector is configured to accommodate a dual in-line memory module (DIMM).

7. The module connector of claim 1, wherein the clamping mechanism includes:
a lever arm configured to apply pressure to the second cross-member;
a cam mechanism configured to translate rotational motion into linear motion to close the first cross-member against the second cross-member;
a spring-loaded actuator configured to bias the first cross-member towards the closed state;
a sliding mechanism configured to move the first cross-member laterally towards the second cross-member; or
a threaded fastener configured to draw the first cross-member and the second cross-member together when rotated.

8. The module connector of claim 1, wherein the locking mechanism includes:
a snap-fit mechanism configured to engage when the two cross-members are in the closed state;
a sliding latch configured to secure the two cross-members in the closed state;
a rotatable cam lock configured to apply pressure to maintain the closed state;
a magnetic locking system configured to hold the two cross-members together; or
a spring-loaded pin configured to engage a corresponding recess when the two cross-members are closed.

9. The module connector of claim 1, wherein the at least one row of pins on each cross-member includes:
conductive metal contacts arranged in a linear array;
spring-loaded pins configured to maintain consistent electrical contact with the PCB;
plated through-holes designed to receive corresponding pins from the PCB;
surface-mount pads arranged to align with contact points on the PCB; or
compliant pin technology providing a pressure fit connection when engaged with the PCB.

10. The module connector of claim 1, wherein the pins on the PCB include:
gold-plated contact pads arranged in one or more linear arrays along an edge of the PCB;
through-hole pins extending from a surface of the PCB;
surface-mount technology (SMT) pads configured to align with corresponding contacts on the two cross-members;
ball grid array (BGA) contacts distributed across a connection area of the PCB; or
edge connector fingers formed as conductive traces on the surface of the PCB.

11. An apparatus comprising:
a motherboard configured to receive a memory module;
a module connector disposed on the motherboard, the module connector comprising:
two cross-members, each cross-member including at least one row of pins;
a clamping mechanism configured to close a first cross-member of the two cross-members against a second cross-member in response to an insertion of the memory module into the module connector; and
a locking mechanism configured to maintain a closed state of the two cross-members and provide electrical contact between the at least one row of pins on each cross-member and pins on the memory module.

12. The apparatus of claim 11, wherein the first cross-member is a fixed cross-member and the second cross-member is a movable cross-member.

13. The apparatus of claim 12, wherein the module connector further comprises a hinge connecting the fixed cross-member and the movable cross-member.

14. The apparatus of claim 11, wherein each cross-member and the memory module include two or more rows of pins.

15. The apparatus of claim 11, wherein the module connector further comprises at least one side latch configured to secure the memory module in the module connector.

16. The apparatus of claim 11, wherein the memory module is a dual in-line memory module (DIMM).

17. The apparatus of claim 11, wherein the clamping mechanism includes at least one of:
a lever arm configured to apply pressure to the second cross-member;
a cam mechanism configured to translate rotational motion into linear motion to close the first cross-member against the second cross-member;
a spring-loaded actuator configured to bias the first cross-member towards the closed state;
a sliding mechanism configured to move the first cross-member laterally towards the second cross-member; or
a threaded fastener configured to draw the first cross-member and the second cross-member together when rotated.

18. The apparatus of claim 11, wherein the locking mechanism includes at least one of:
a snap-fit mechanism configured to engage when the two cross-members are in the closed state;
a sliding latch configured to secure the two cross-members in the closed state;
a rotatable cam lock configured to apply pressure to maintain the closed state;
a magnetic locking system configured to hold the two cross-members together; or
a spring-loaded pin configured to engage a corresponding recess when the two cross-members are closed.

19. The apparatus of claim 11, wherein the motherboard includes input/output circuitry configured to manage communications between the memory module and other components of the apparatus.

20. A method comprising:
aligning a printed circuit board (PCB) with two cross-members of a module connector, each cross-member including at least one row of pins;
inserting the PCB into the module connector;
activating a clamping mechanism to close a first cross-member of the two cross-members against a second cross-member in response to insertion of the PCB; and
engaging a locking mechanism to maintain a closed state of the two cross-members to establish electrical contact between the at least one row of pins on each cross-member and pins on the PCB.
